(19) United States
(12) Patent Application Publication
(10) Pub. No.: US 2025/0373116 A1
(43) Pub. Date: Dec. 4, 2025

(54) INTEGRATED COUNTERWEIGHT FOR AN ELECTRIC MACHINE

(71) Applicant: Hyliion Holdings Corp, Cedar Park, TX (US)

(72) Inventors: Alex William Ariapad, Cincinnati, OH (US); Joshua Tyler Mook, Cincinnati, OH (US); Aigbedion Akwara, Cincinnati, OH (US)

(21) Appl. No.: 18/732,688

(22) Filed: Jun. 4, 2024

(51) Int. Cl. H02K 7/18

(52) U.S. Cl. CPC H02K 7/1884

(57) ABSTRACT

A linear electric machine includes at least one shaft and a stator assembly supporting the at least one shaft. The stator assembly includes a magnet carrier supporting one or more magnets. The magnet carrier defines an inner cavity therein. The linear electric machine further includes a bearing assembly supporting an end of the at least one shaft. The bearing assembly includes a bearing housing and a bearing within the bearing housing. The linear electric machine also includes a counterweight positioned within the inner cavity of the magnet carrier for counteracting movement of the magnet carrier.

### FIELD

The present disclosure relates generally to electric machines, and more particularly to an integrated counterweight for an electric machine, such as a generator of a closed-cycle engine.

### BACKGROUND

Large vehicles may be used to efficiently transport cargo. Large, wheeled vehicles pull trailers to transport large volumes of cargo on land, wherein the combination of the vehicle and the trailer can weigh between 30,000 pounds up to 140,000 pounds for a tandem loaded trailer. These vehicles may be referred to as “powered semi-tractors”, “semi-tractors”, “semis”, or “trucks.” Trucks may be used on roads such as highways and in urban areas but may also be used on unimproved roads or uneven terrain. In a traditional truck with an internal combustion engine, the internal combustion engine may be sized in the range of 15 liters to provide enough power to propel the vehicle and the trailer.

Such vehicles may be designed with unique configurations capable of integrating one of several different types of engines, such as a closed-cycle engine, to generate electric power for charging an array of batteries under a plurality of operating conditions.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a side view of an embodiment of a wheeled vehicle capable of transporting cargo over an extended range according to the present disclosure;

FIG. 2 illustrates a detailed, top view of an embodiment of a wheeled vehicle capable of transporting cargo over an extended range according to the present disclosure;

FIG. 3 illustrates a schematic diagram of an embodiment of the vehicle depicted in FIGS. 1 and 2;

FIG. 4 illustrates a perspective view of an embodiment of a closed-cycle engine for a vehicle according to the present disclosure;

FIG. 5 illustrates a cross-sectional view of an embodiment of one of the closed-cycle engines according to the present disclosure;

FIG. 6 illustrates a cross-sectional view of a portion of the closed-cycle engine illustrated in FIG. 4 along section line 6-6 according to the present disclosure;

FIG. 7 illustrates a schematic diagram of an embodiment of a pressure control system of a closed-cycle engine according to the present disclosure;

FIG. 8 illustrates a cross-sectional view of an embodiment of a portion of a linear electric machine according to the present disclosure, particularly illustrating a counterweight positioned within an inner cavity of a magnet carrier of the linear electric machine;

FIG. 9 illustrates a cross-sectional view of another embodiment of a portion of a linear electric machine according to the present disclosure, particularly illustrating a counterweight positioned within an inner cavity of a magnet carrier of the linear electric machine with the magnet carrier fully stroked right;

FIG. 10 illustrates a cross-sectional view of still another embodiment of a portion of a linear electric machine according to the present disclosure, particularly illustrating the counterweight and the magnet carrier in the middle of a stroke such that pressures are equalized across the magnet carrier and the counterbalance; and

FIG. 11 illustrates a cross-sectional view of another embodiment of a portion of a linear electric machine according to the present disclosure, particularly illustrating a counterweight positioned within an inner cavity of a magnet carrier of the linear electric machine with the magnet carrier fully stroked left.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

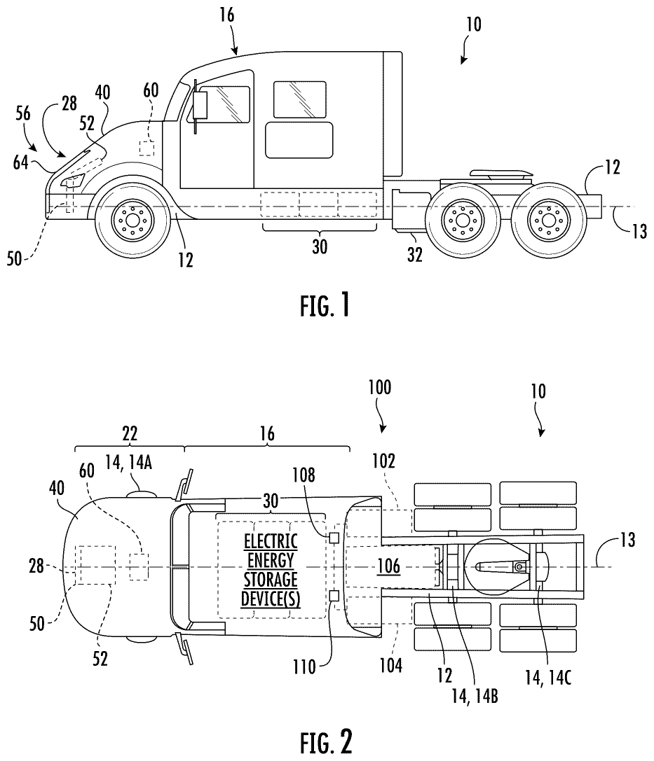

Referring now to the drawings, FIGS. 1-3 illustrate various views of an embodiment of a wheeled vehicle 10 along a longitudinal axis 13 according to the present disclosure. In particular, FIGS. 1 and 2 depict side and top partial views of the wheeled vehicle 10, respectively, such as a truck or semi-tractor used to pull one or more trailers with cargo. As shown generally in FIGS. 1-3, components of the vehicle 10 may include, but are not limited to, a chassis 12, which may support multiple axles 14, a cab 16, a compartment 22 containing a radiator assembly 28, an engine assembly 100 having one or more closed-cycle engines 102, 104 mounted to the chassis 12 aft of the radiator assembly 28, e.g., outside of the compartment 22, a hood 40 for accessing the compartment 22, an array of energy storage devices 30 (e.g., batteries), and a motor/generator 32 coupled to at least one of the axles 14. Moreover, as shown particularly in FIG. 2, the one or more closed-cycle engines 102, 104 may be fluidly coupled with one or more fuel tanks 106. Furthermore, as shown in FIG. 2, the vehicle 10 may be equipped with one or more power converters 108, 109 coupled to the closed-cycle engines 102, 104 and the array of energy storage devices 30.

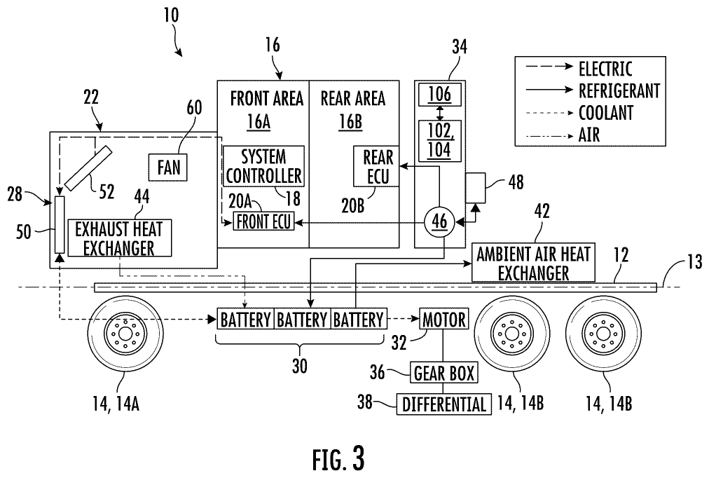

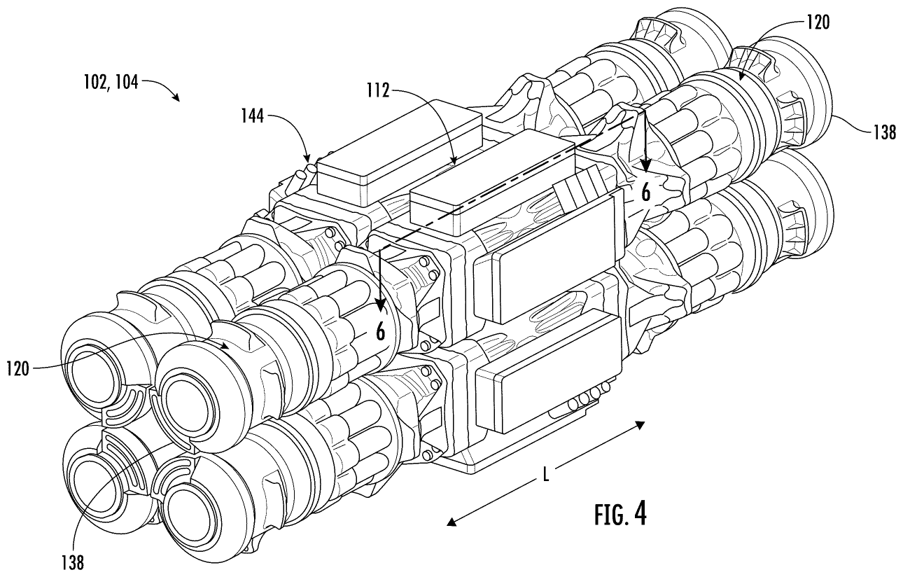

In an embodiment, the chassis 12 may be formed with two frame members such as C-channels arranged parallel to each other. Further, in an embodiment, as shown in FIGS. 2 and 3, the axles 14 coupled to the chassis 12 may include a front axle 14A located under the compartment 22 and rear axles 14B and 14C located behind the cab 16.

Moreover, in an embodiment, the compartment 22 includes mounts for supporting the radiator assembly 28. Thus, the radiator assembly 28 may be positioned at the front of the compartment 22 for cooling the closed-cycle engines 102, 104. As such, in an embodiment, coolant, such as glycol or some other anti-freeze liquid, may be circulated through the radiator assembly 28 and the closed-cycle engines 102, 104 to remove heat from the closed-cycle engines 102, 104 and transfer the heat to the ambient air as further described herein.

Referring particularly to FIG. 3, the cab 16 may further include a system controller 18 for monitoring systems on the vehicle 10 and one or more environmental control units (ECU) 20 having air conditioning and heating options. As depicted in FIG. 3, a front area 16A of the cab 16 may have a front ECU 20A for managing cab temperatures and a rear area 16B of the cab 16 may have a rear ECU 20B for managing rear area temperatures. In such embodiments, the front and rear ECUs 20A, 20B may be fluidly coupled to a compressor 46 and a refrigerant heat exchanger 48 as part of an air conditioning system for the cab 16 and a thermal management system for the energy storage devices 30.

In an embodiment, as shown in FIG. 3, the vehicle 10 may further include an ambient air heat exchanger 42 for heat exchange between the energy storage devices 30 and the ambient air and an exhaust heat exchanger 44 for extracting heat from exhaust gases to heat the energy storage devices 30.

Further, as shown in FIGS. 1-3, an array of energy storage devices 30 may be positioned in various locations on the vehicle 10. In some embodiments, as shown, the energy storage devices 30 may be located on the chassis 12. In some embodiments, the energy storage devices 30 may be located between, under, or around the rails of the chassis 12. Moreover, in an embodiment, the array of energy storage devices 30 may be connected in series, parallel or some combination. Thus, in an embodiment, electric power generated by the generator 26 may be used to charge the array of energy storage devices 30.

Referring to FIGS. 2 and 3, the motor/generator 32 may be coupled to at least one of the axles 14. For example, in some embodiments, the motor/generator 32 may be integrated with one of the axles 14 as an e-axle configuration or located in a hub of a wheel coupled to one of the axles 14 as a hub motor/generator configuration. Moreover, embodiments of the vehicle 10 may include the motor/generator 32 coupled to gearboxes or differentials. For example, as depicted in FIG. 3, the motor/generator 32 may be coupled to a three-speed centralized gearbox 36 with a two-speed rear differential 38 to provide six discrete gear ratios. In some embodiments, the vehicle 10 may be configured with a plurality of motor/generators 32, with a motor/generator 32 coupled to each wheel or pair of wheels. Moreover, as shown in FIGS. 2 and 3, behind the cab 16, the rear pack 34 may be configured to hold one or more fuel tanks 106 for use by closed-cycle engines 102, 104.

The vehicle 10 may also include a fan 60 positioned aft of the first and second radiators 50, 52 and forward of the closed-cycle engines 102, 104 so as to draw air into the first and second radiators 50, 52 and down to the ground 74. For example, in an embodiment, the fan 60 is configured to draw the incoming airflow 56 through the grille 64, across the first radiator 50, across the second radiator 52, and then out of the vehicle 10 directly to the ground 74.

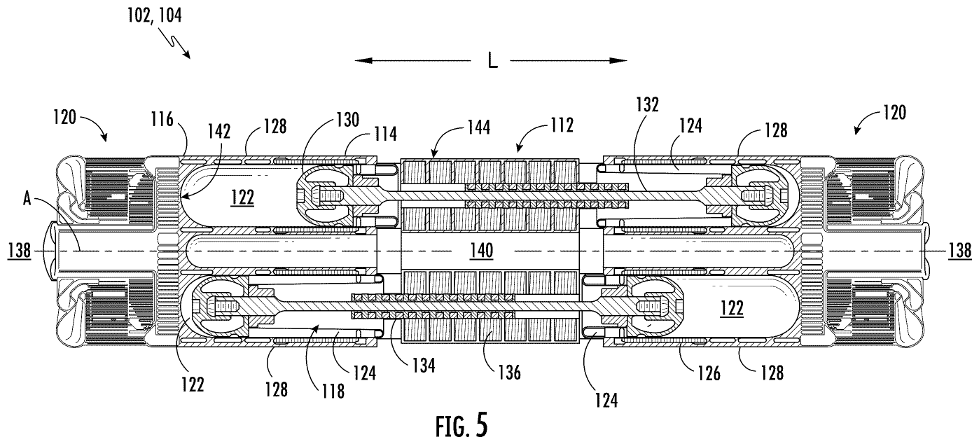

Referring now to FIGS. 4 and 5, various views of an embodiment of one of the closed-cycle engines 102, 104 along longitudinal axis A and operably coupled to a load device 112 are illustrated according to the present disclosure. FIG. 4 illustrates a perspective view of an embodiment of one of the closed-cycle engines 102, 104 according to the present disclosure. FIG. 5 illustrates a cross-sectional view of an embodiment of one of the closed-cycle engines 102, 104 according to the present disclosure. As shown in FIG. 5, in an embodiment, the closed-cycle engine 102, 104 contains a substantially fixed mass of an engine working fluid to which and from which thermal energy is exchanged at a respective cold side heat exchanger 114 and a hot side heat exchanger 116. In an embodiment, the engine working fluid is helium. In other embodiments, the engine working fluid may include air, nitrogen, hydrogen, helium, or any appropriate compressible fluid, or combinations thereof.

In still various embodiments, any suitable engine working fluid may be utilized in accordance with the present disclosure. In exemplary embodiments, the engine working fluid may include a gas, such as an inert gas. For example, a noble gas, such as helium may be utilized as the engine working fluid. Exemplary working fluids preferably are inert, such that they generally do not participate in chemical reactions such as oxidation within the environment of the closed-cycle engine 102, 104. Exemplary noble gasses include monoatomic gases such as helium, neon, argon, krypton, or xenon, as well as combinations of these. In some embodiments, the engine working fluid may include air, oxygen, nitrogen, or carbon dioxide, as well as combinations of these. In still various embodiments, the engine working fluid may be liquid fluids of one or more elements described herein, or combinations thereof. It should further be appreciated that various embodiments of the engine working fluid may include particles or other substances as appropriate for the engine working fluid.

In various embodiments, the load device 112 is a mechanical work device or an electric machine. In an embodiment, the load device 112 is a pump, compressor, or other work device. In another embodiment, the load device 112 as an electric machine is configured as a generator producing electric energy from movement of a piston assembly 118 at the closed-cycle engine 102, 104. In still another embodiment, the electric machine is configured as a motor providing motive force to move or actuate the piston assembly 118, such as to provide initial movement (e.g., a starter motor). In still various embodiments, the electric machine defines a motor and generator or other electric machine apparatus such as described further herein.

A heater body 120 is thermally coupled to the closed-cycle engine 102, 104. The heater body 120 may generally define any apparatus for producing or otherwise providing a heating working fluid such as to provide thermal energy to the engine working fluid. Various embodiments of the heater body 120 are further provided herein. Exemplary heater bodies 120 may include, but are not limited to, a combustion or detonation assembly, an electric heater, a nuclear energy source, a renewable energy source such as solar power, a fuel cell, a heat recovery system, or as a bottoming cycle to another system. Exemplary heater bodies 120 at which a heat recovery system may be defined include, but are not limited to, industrial waste heat generally, gas or steam turbine waste heat, nuclear waste heat, geothermal energy, decomposition of agricultural or animal waste, molten earth or metal or steel mill gases, industrial drying systems generally or kilns, or fuel cells. In an embodiment, the heater body 120 providing thermal energy to the engine working fluid may include all or part of a combined heat and power cycle, or cogeneration system, or power generation system generally.

In still various embodiments, the heater body 120 is configured to provide thermal energy to the engine working fluid via a heating working fluid. The heating working fluid may be based, at least in part, on heat and liquid, gaseous, or other fluid provided by one or more fuel sources and oxidizer sources providing a fuel and oxidizer. In various embodiments, the fuel includes, but is not limited to, hydrocarbons and hydrocarbon mixtures generally, “wet” gases including a portion of liquid (e.g., humid gas saturated with liquid vapor, multiphase flow with approximately 10% liquid and approximately 90% gas, natural gas mixed with oil, or other liquid and gas combinations, etc.), petroleum or oil (e.g., Arabian Extra Light Crude Oil, Arabian Super Light, Light Crude Oil, Medium Crude Oil, Heavy Crude Oil, Heavy Fuel Oil, etc.), natural gas (e.g., including sour gas), biodiesel condensate or natural gas liquids (e.g., including liquid natural gas (LNG)), dimethyl ether (DME), distillate oil #2 (DO2), ethane (C2), methane, high H2 fuels, fuels including hydrogen blends (e.g., propane, butane, liquefied petroleum gas, naphtha, etc.), diesel, kerosene (e.g., jet fuel, such as, but not limited to, Jet A, Jet A-1, JP1, etc.), alcohols (e.g., methanol, ethanol, etc.), synthesis gas, coke over gas, landfill gases, etc., or combinations thereof.

In various embodiments, as shown in FIG. 5, the hot side heat exchanger 116 outputs thermal energy to the engine working fluid at an expansion chamber 122 of the closed-cycle engine 102, 104. The hot side heat exchanger 116 is positioned at the expansion chamber 122 of the engine in thermal communication with the heater body 120. In other embodiments, the hot side heat exchanger 116 may be separate from the heater body 120, such that the heating working fluid is provided in thermal communication, or additionally, in fluid communication with the hot side heat exchanger 116. In particular embodiments, the hot side heat exchanger 116 is positioned in direct thermal communication with the heater body 120 and the expansion chamber 122 of the engine 102, 104 such as to receive thermal energy from the heater body 120 and provide thermal energy to the engine working fluid within the closed-cycle engine 102, 104.

In still various embodiments, the heater body 120 may include a single thermal energy output source to a single expansion chamber 122 of the engine. As such, the closed-cycle engine 102, 104 may include a plurality of heater assemblies each providing thermal energy to the engine working fluid at each expansion chamber 122. In other embodiments, such as depicted in regard to FIG. 4, the heater body 120 may provide thermal energy to a plurality of expansion chambers 122 of the closed-cycle engine 102, 104.

The closed-cycle engine 102, 104 further includes a chiller assembly, such as chiller assembly 126 further described herein. The chiller assembly 126 is configured to receive and displace thermal energy from a compression chamber 124 of the closed-cycle engine 102, 104. Further, in an embodiment, the cold side heat exchanger 114 is thermally coupled to the compression chamber 124 of the closed cycle engine 102, 104 and the chiller assembly 126. In one embodiment, the cold side heat exchanger 114 and a piston body 128 defining the compression chamber 124 of the closed-cycle engine 102, 104 are together defined as an integral, unitary structure. In still various embodiments, the cold side heat exchanger 114, at least a portion of the piston body 128 defining the compression chamber 124, and at least a portion of the chiller assembly 126 together define an integral, unitary structure.

In various embodiments, as shown in FIG. 5, the chiller assembly 126 is a bottoming cycle to the closed-cycle engine 102, 104. As such, the chiller assembly 126 is configured to receive thermal energy from the closed-cycle engine 102, 104. The thermal energy received at the chiller assembly 126, such as through a cold side heat exchanger 114, or a cold side heat exchanger 114 further herein, from the closed-cycle engine 102, 104 is added to a chiller working fluid at the chiller assembly 126. In various embodiments, the chiller assembly 126 defines a Rankine cycle system through which the chiller working fluid flows in closed loop arrangement with a compressor. In some embodiments, the chiller working fluid is further in closed loop arrangement with an expander. In various embodiments, the cold side heat exchanger 114 may include a condenser or radiator. The cold side heat exchanger 114 is positioned downstream of the compressor and upstream of the expander and in thermal communication with the compression chamber 124 of the closed-cycle engine 102, 104. In various embodiments, the cold side heat exchanger 114 may generally define an evaporator receiving thermal energy from the closed-cycle engine 102, 104.

Various embodiments of the closed-cycle engine 102, 104 include control systems and methods of controlling various sub-systems disclosed herein, such as, but not limited to, the fuel source, the oxidizer source, the cooling fluid source, the heater body 120, the chiller assembly 126, and the load device 112, including any flow rates, pressures, temperatures, loads, discharges, frequencies, amplitudes, or other suitable control properties associated with the closed-cycle engine 102, 104.

In an embodiment, the control system can control the closed-cycle engine 102, 104 and its associated balance of plant to generate a temperature differential, such as a temperature differential at the engine working fluid relative to the heating working fluid and the chiller working fluid. Thus, the closed-cycle engine 102, 104 defines a hot side, such as at the expansion chamber 122, and a cold side, such as at the compression chamber 124. The temperature differential causes free piston assemblies 118 to move within their respective piston chambers defined at respective piston bodies 128. The movement of pistons 130 within the respective piston bodies 128 causes the electric machine to generate electrical power. The generated electrical power can be provided to the energy storage devices 30 for charging thereof. The control system monitors one or more operating parameters associated with the closed-cycle engine 102, 104, such as piston movement (e.g., amplitude and position), as well as one or more operating parameters associated with the electric machine, such as voltage or electric current. Based on such parameters, the control system generates control commands that are provided to one or more controllable devices of the closed-cycle engine 102, 104. The controllable devices execute control actions in accordance with the control commands. Accordingly, the desired output of the closed-cycle engine 102, 104 can be achieved.

Referring still to FIG. 5, each piston assembly 118 is positioned within a volume or piston chamber defined by a wall defining the piston body 128. The volume within the piston body 128 is separated into a first chamber, or hot chamber, or expansion chamber 122 and a second chamber, or cold chamber (relative to the hot chamber), or compression chamber 124 by a piston 130 of the piston assembly 118. The expansion chamber 122 is positioned thermally proximal to the heater body 120 relative to the compression chamber 124 thermally distal to the heater body 120. The compression chamber 124 is positioned thermally proximal to the chiller assembly 126 relative to the expansion chamber 122 thermally distal to the chiller assembly 126.

In various embodiments, the piston assembly 118 defines a double-ended piston assembly 118 in which a pair of pistons 130 is each coupled to a connection member 132. The connection member 132 may generally define a rigid shaft or rod extended along a direction of motion of the piston assembly 118. In other embodiments, the connection members 132 includes one or more springs or spring assemblies, such as further provided herein, providing flexible or non-rigid movement of the connection member 132. In still other embodiments, the connection member 132 may further define substantially U- or V-connections between the pair of pistons 130.

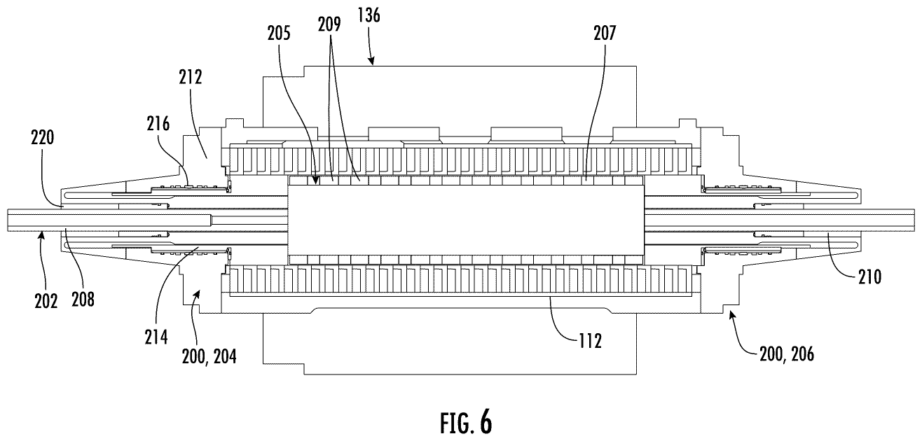

Each piston 130 is positioned within the piston body 128 such as to define the expansion chamber 122 and the compression chamber 124 within the volume of the piston body 128. The load device 112 is operably coupled to the piston assembly 118 such as to extract energy therefrom, provide energy thereto, or both. The load device 112 defining an electric machine is in magnetic communication with the closed-cycle engine 102, 104 via the connection member 132. In various embodiments, the piston assembly 118 includes a dynamic member 134 positioned in operable communication with a stator assembly 136 of the electric machine. The stator assembly 136 may generally include a magnet array 205 or carrier for supporting one or more magnets 209 (FIG. 6) and a plurality of windings 207 wrapped circumferentially relative to the piston assembly 118 and extended along a lateral direction L. In an embodiment, such as depicted in regard to FIG. 4, the dynamic member 134 is connected to the connection member 132. The electric machine may further be positioned between the pair of pistons 130 of each piston assembly 118. Dynamic motion of the piston assembly 118 generates electricity at the electric machine. For example, linear motion of the dynamic member 134 between each pair of chambers defined by each piston 130 of the piston assembly 118 generates electricity via the magnetic communication with the stator assembly 136 surrounding the dynamic member 134.

Referring still to FIG. 5, in various embodiments, the hot side heat exchanger 116 may further define at least a portion of the expansion chamber 122. In an embodiment, such as further described herein, the hot side heat exchanger 116 defines a unitary or monolithic structure with at least a portion of the piston body 128, such as to define at least a portion of the expansion chamber 122. In some embodiments, the heater body 120 further defines at least a portion of the hot side heat exchanger 116, such as to define a unitary or monolithic structure with the hot side heat exchanger 116, such as further described herein.

Furthermore, as shown in FIGS. 4 and 5, the closed-cycle engine 102, 104 defines an outer end 138 and an inner end 140 (FIG. 5) each relative to a lateral direction L. The outer ends 138 define laterally distal ends of the closed-cycle engine 102, 104 and the inner ends 140 define laterally inward or central positions of the closed-cycle engine 102, 104. In one embodiment, such as depicted in regard to FIG. 5, the heater body 120 is positioned at outer ends 138 of the closed-cycle engine 102, 104. The piston body 128 includes a dome structure 142 at the expansion chamber 122. The expansion chamber dome structure 142 provides reduced surface area heat losses across the outer end 138 of the expansion chamber 122. In various embodiments, the pistons 130 of the piston assembly 118 further include domed pistons 130 corresponding to the expansion chamber 122 dome. The dome structure 142, the domed piston 130, or both may provide higher compressions ratios at the chambers 122, 124, such as to improve power density and output.

In various embodiments, such as depicted in regard to FIG. 5, the load device 112 is positioned at the inner end 140 of the closed-cycle engine 102, 104 between laterally opposing pistons 130. The load device 112 may further include a machine body 144 positioned laterally between the piston bodies 128. The machine body 144 surrounds and houses the stator assembly 136 of the load device 112 defining the electric machine. The machine body 144 further surrounds the dynamic member 134 of the electric machine attached to the connection member 132 of the piston assembly 118.

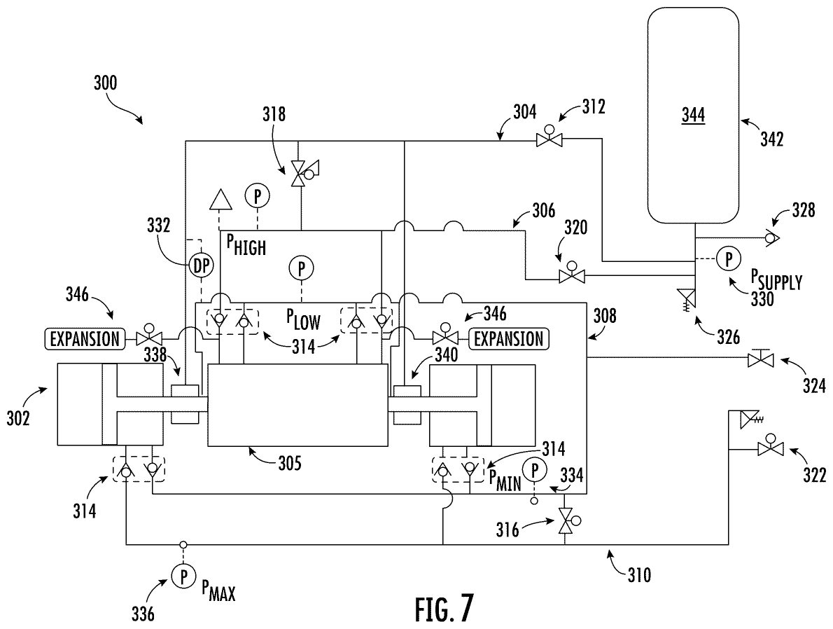

Referring now to FIG. 6, a cross-sectional view of a portion of the closed-cycle engine(s) 102, 104 having a bearing assembly 200 according to the present disclosure is illustrated. FIG. 7 illustrates a schematic diagram of a pressure control system for the closed-cycle engine(s) 102, 104 that can be incorporated into the vehicle 10 according to the present disclosure.

Referring particularly to FIG. 6, the closed-cycle engine 102, 104 includes a shaft 202 for driving one of the piston assemblies 118 (not shown in FIG. 6) described herein. Moreover, as shown, the closed-cycle engine 102, 104 includes the stator assembly 136 supporting the shaft 202 and housing the load device 112. Thus, as shown, the bearing assembly 200 is configured to support an end of the shaft 202. More specifically, as shown in FIG. 6, a first bearing assembly 204 may support a forward end 208 of the shaft 202 and a second bearing assembly 206 may support an aft end 210 of the shaft 202.

Moreover, in an embodiment, as shown in FIG. 6, the bearing assembly 200 may include a bearing housing 212 and a fluid bearing 214 within the bearing housing 212. Thus, in an embodiment, the fluid bearing 214 described herein may be a forward bearing, an aft bearing, or both of the closed-cycle engine 102, 104. Furthermore, as shown, the bearing housing 212 includes an opening 220 for receiving the shaft 202 therethrough.

Referring particularly to FIG. 7, a schematic diagram of an embodiment of a pressure control system 300 for the closed-cycle engine(s) 102, 104 that can be incorporated into the vehicle 10 according to the present disclosure is illustrated. In particular, as shown, the pressure control system 300 includes a plurality of cylinder-piston assemblies 302, only one of which is shown. Moreover, as shown, the pressure control system 300 includes a network of fluid passageways 304, 306, 308, 310 and a plurality of valves (or vents) 312, 314, 316, 318, 320, 322, 324 in fluid communication with the network of fluid passageways 304, 306, 308, 310. For example, as shown, the plurality of valves 312, 314, 316, 318, 320, 322, 324 may include, at least, one or more check valves 314, a bearing boost control valve 312, a return-to-tank solenoid valve 320, a bearing delta pressure (dP) control valve, one or more regulator valves, one or more vent valves, and/or one or more service valves 324. In addition, as shown, the pressure control system 300 may also include one or more solenoid valves, overpressure safety devices 326, filters, etc. Moreover, in an embodiment, the pressure control system 300 may include one or more fill or vent ports 328.

Moreover, as shown, the pressure control system 300 may further include various pressure sensors for monitoring pressure throughout the pressure control system 300. For example, as shown in FIG. 7, the pressure control system 300 may include a supply pressure sensor 330, a dP bearing pressure sensor 332, a P_{MIN} (i.e., minimum pressure) pressure sensor 334, and/or a P_{MAX} (i.e., maximum pressure) pressure sensor 336.

In addition, as shown, the pressure control system 300 includes a load device, similar to load device 112, and one or more fluid bearings 338, 340 associated with each of the plurality of cylinder-piston assemblies 302. Accordingly, as shown, the fluid bearings 338, 340 are in fluid communication with the network of fluid passageways 304, 306, 308, 310.

Still referring to FIG. 7, the pressure control system 300 further includes a pressurized tank 342 containing a working fluid 344, such as helium. Thus, in an embodiment, the pressurized tank 342 may be selectively fluidly coupled with the plurality of cylinder-piston assemblies 302 (and thus the fluid bearings 338, 340) via the network of fluid passageways 304, 306, 308, 310 and the plurality of valves 312, 314, 316, 318, 320, 322, 324.

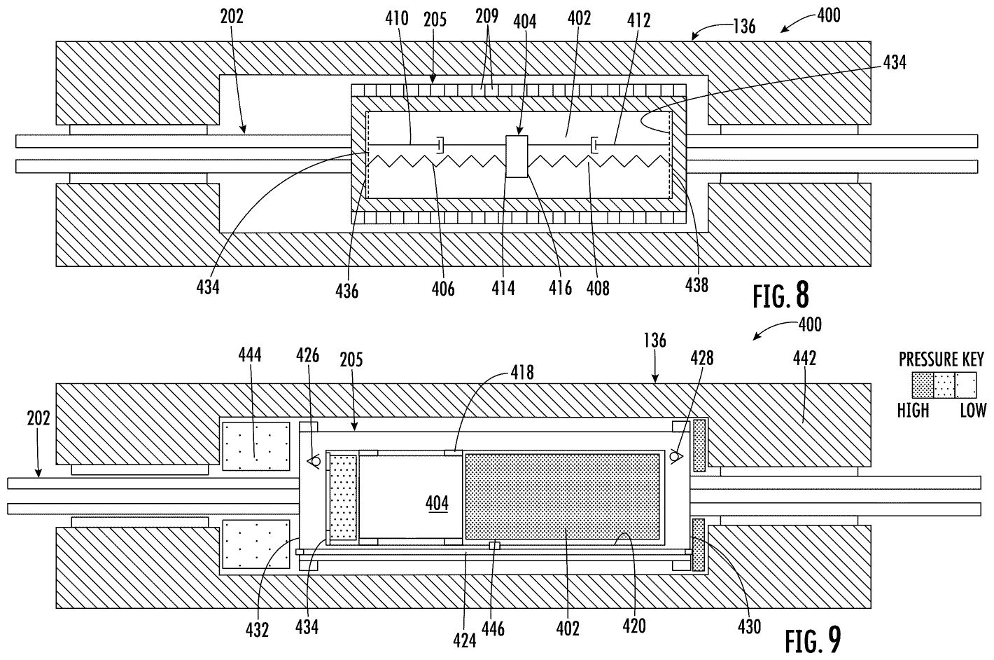

Furthermore, as shown in FIGS. 8-11, various cross-sectional views of a portion of a linear electric machine 400, such as the of the closed-cycle engine 102, 104, are illustrated according to the present disclosure. More specifically, as shown, the linear electric machine 400 includes the shaft 202 described herein and the stator assembly 136 supporting the shaft 202. Furthermore, as shown and illustrated in FIGS. 8-10, the stator assembly 136 also includes the magnet carrier 205 supporting a plurality of magnets 209. Moreover, as shown, the magnet carrier 205 defines an inner cavity 402. Further, in an embodiment, the linear electric machine 400 may include a primary piston assembly (corresponding to one of the piston assemblies 118 described herein and illustrated in FIG. 5) and the bearing assembly 200 supporting an end of the shaft 202 (as shown in FIG. 6). In addition, as shown, the linear electric machine 400 includes a counterweight 404 positioned within the inner cavity 402 of the magnet carrier 205 for counteracting movement of the magnet carrier 205.

Referring particularly to FIG. 8, in an embodiment, the counterweight 404 is mounted within the inner cavity 402 of the magnet carrier 205 via a first spring 406 and/or a first damper 410. More specifically, as shown in the illustrated embodiment, the counterweight 404 is mounted within the inner cavity 402 of the magnet carrier 205 via the first spring 406 and the first damper 410 on a first side 414 of the counterweight 404 and a second spring 408 and a second damper 412 on an opposing, second side 416 of the counterweight 404. In another embodiment, the counterweight 404 may be mounted within the inner cavity 402 of the magnet carrier 205 via only one spring and/or one damper on a single side thereof. Thus, in such embodiments, the counterweight 404 is suspended within the inner cavity 402 of the magnet carrier 205 via the first spring 406, the first damper 410, the second spring 408, and the second damper 412. Accordingly, in such embodiment, the counterweight 404 is configured to move 180° out of phase with the movement of the magnet carrier 205 so as to balance the magnet carrier 205. Accordingly, in an embodiment, a mass of the counterweight 404 is proportional to a mass of the magnet carrier 205. For example, in an embodiment, the mass of the counterweight 404 may be substantially equivalent to the floater mass.

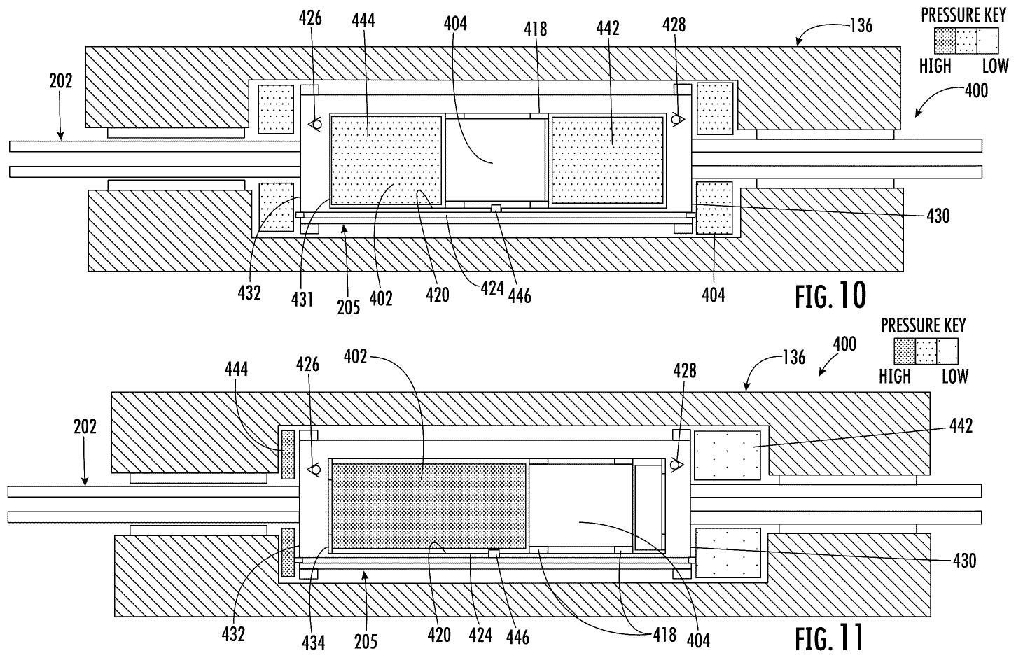

Referring particularly to FIGS. 9-11, various cross-sectional views of a portion of the linear electric machine 400 described herein according to the present disclosure are illustrated. In particular, FIG. 9 illustrates the counterweight 404 positioned within the inner cavity 402 of the magnet carrier 205, with the magnet carrier fully stroked right and the counterbalance 404 positioned fully left. FIG. 10 illustrates the counterweight 404 and the magnet carrier 205 in the middle of a stroke such that pressures are equalized across the magnet carrier 205 and the counterbalance 404. FIG. 11 illustrates the counterweight 404 positioned within the inner cavity 402 of the magnet carrier 205, with the magnet carrier 205 fully stroked left and the counterbalance 404 positioned fully right.

In addition, as shown, the counterweight 404 is mounted within the inner cavity 402 of the magnet carrier 205 via one or more bearings 418 that allow the counterweight 404 to slide along one or more inner surfaces 420 of the inner cavity 402 of the magnet carrier 205. In such embodiments, as shown, the magnet carrier 205 may also include one or more vent ports 424 for allowing fluid within the inner cavity 402 to passively exit therefrom.

In additional embodiments, as shown, the linear electric machine 400 may further include one or more check valves 426, 428 for allowing fluid (e.g., air) to enter the inner cavity 402 of the magnet carrier 205. More specifically, as shown, the check valve(s) 426, 428 may include a first check valve 426 and a second check valve 428. As such, the first check valve 426 allows the fluid to enter the inner cavity 402 of the magnet carrier 205 from a first side 430 of the magnet carrier 205, whereas the second check valve 428 allows the fluid to enter the inner cavity 402 of the magnet carrier 205 from an opposing, second side 432 of the magnet carrier 205. In such embodiments, the fluid is configured to move the counterweight 404 within the inner cavity 402 of the magnet carrier 205, e.g., from one side to another by sliding along the inner surfaces 420 of the inner cavity 402. In particular embodiments, as shown in FIG. 9, when the magnet carrier 205 is stroked fully right, the check valve 428 opens to allow high pressure gas into the inner cavity 402 of the magnet carrier 205 on the first side 430 of the magnet carrier 205 to move the counterweight 404 in an opposite direction (e.g., to the left). More specifically, as shown, as the magnet carrier 205 moves to the right, a first chamber 442 acts as a compression chamber on the first side 430 of the magnet carrier 205 and a second chamber 442 acts as an expansion chamber 444 on the second side 432 of the magnet carrier 205. Furthermore, in an embodiment, as shown in FIG. 11, when the magnet carrier 205 is stroked fully left, the check valve 426 opens to allow high pressure gas into the inner cavity 402 of the magnet carrier 205 on the second side 432 of the magnet carrier 205 to move the counterweight 404 in an opposite direction (e.g., to the right). More specifically, as shown, as the magnet carrier 205 moves to the left, the first chamber 442 acts as an expansion chamber on the first side 430 of the magnet carrier 205 and the second chamber 444 acts as a compression chamber on the second side 432 of the magnet carrier 205. Thus, such chambers 442, 444 allow the counterweight 404 to move easily in an opposite direction of the magnet carrier 205. Accordingly, the counterweight 404 balances movement of the magnet carrier 205 by moving approximately 180° out of phase with the magnet carrier 205. In addition, as shown in FIGS. 9-11, a bore 446 in the magnet carrier 205 is configured to slowly vent the inner cavity 402 to an expansion side.

Furthermore, in an embodiment, the linear electric machine 400 may include one or more stoppers 434 arranged within the inner cavity 402 of the magnet carrier 205 for limiting movement of the counterweight 404 within the magnet carrier 205. For example, as shown in FIGS. 8-11, the stopper(s) 434 may be arranged at each end 436, 438 of the inner cavity 402 of the magnet carrier 205.

Further aspects are provided by the subject matter of the following clauses:

A linear electric machine, comprising: at least one shaft; a stator assembly supporting the at least one shaft, the stator assembly comprising a magnet carrier supporting one or more magnets, the magnet carrier defining an inner cavity therein; a bearing assembly supporting an end of the at least one shaft, the bearing assembly comprising a bearing housing and a bearing within the bearing housing; and a counterweight positioned within the inner cavity of the magnet carrier for counteracting movement of the magnet carrier.

The linear electric machine of any preceding clause, wherein the counterweight is mounted within the inner cavity of the magnet carrier via at least one of a first spring or a first damper.

The linear electric machine of any preceding clause, wherein the counterweight is mounted within the inner cavity of the magnet carrier via the first spring and the first damper on a first side of the counterweight and a second spring and a second damper on an opposing, second side of the counterweight.

The linear electric machine of any preceding clause, wherein the counterweight is suspended within the inner cavity of the magnet carrier via the first spring, the first damper, the second spring, and the second damper.

The linear electric machine of any preceding clause, wherein the counterweight is mounted within the inner cavity of the magnet carrier via one or more bearings that allow the counterweight to slide along one or more inner surfaces of the inner cavity of the magnet carrier.

The linear electric machine of any preceding clause, wherein the counterweight further comprises one or more vent ports.

The linear electric machine of any preceding clause, wherein the magnet carrier further comprises one or more vent ports for allowing fluid to passively exit the inner cavity of the magnet carrier.

The linear electric machine of any preceding clause, further comprising one or more check valves for allowing fluid to enter the inner cavity of the magnet carrier, wherein the fluid is configured to move the counterweight within the inner cavity of the magnet carrier.

The linear electric machine of any preceding clause, wherein the one or more check valves comprise a first check valve and a second check valve, and wherein the first check valve allows the fluid to enter the inner cavity of the magnet carrier from a first side of the magnet carrier and the second check valve allows the fluid to enter the inner cavity of the magnet carrier from an opposing, second side of the magnet carrier.

The linear electric machine of any preceding clause, further comprising one or more stoppers arranged within the inner cavity of the magnet carrier for limiting movement of the counterweight within the magnet carrier.

The linear electric machine of any preceding clause, wherein a mass of the counterweight is proportional to a mass of the magnet carrier.

An assembly, comprising: a closed-cycle engine; a load device in magnetic communication with the closed-cycle engine via a shaft; a piston assembly comprising pair of pistons each coupled to the shaft; a stator assembly comprising a magnet carrier supporting one or more magnets and a plurality of windings wrapped circumferentially relative to the piston assembly, the magnet carrier defining an inner cavity therein; a bearing assembly supporting an end of the shaft, the bearing assembly comprising a bearing housing and a bearing within the bearing housing; and a counterweight positioned within the inner cavity of the magnet carrier for counteracting movement of the magnet carrier.

The assembly of any preceding clause, wherein the counterweight is mounted within the inner cavity of the magnet carrier via at least one of a first spring or a first damper.

The assembly of any preceding clause, wherein the counterweight is mounted within the inner cavity of the magnet carrier via the first spring and the first damper on a first side of the counterweight and a second spring and a second damper on an opposing, second side of the counterweight.

The assembly of any preceding clause, wherein the counterweight is suspended within the inner cavity of the magnet carrier via the first spring, the first damper, the second spring, and the second damper.

The assembly of any preceding clause, wherein the counterweight is mounted within the inner cavity of the magnet carrier via one or more bearings that allow the counterweight to slide along one or more inner surfaces of the inner cavity of the magnet carrier.

The assembly of any preceding clause, wherein the counterweight further comprises one or more vent ports.

The assembly of any preceding clause, wherein the magnet carrier further comprises one or more vent ports for allowing fluid to passively exit the inner cavity of the magnet carrier.

The assembly of any preceding clause, further comprising one or more check valves for allowing fluid to enter the inner cavity of the magnet carrier, wherein the fluid is configured to move the counterweight within the inner cavity of the magnet carrier, wherein the one or more check valves comprise a first check valve and a second check valve, and wherein the first check valve allows the fluid to enter the inner cavity of the magnet carrier from a first side of the magnet carrier and the second check valve allows the fluid to enter the inner cavity of the magnet carrier from an opposing, second side of the magnet carrier.

The assembly of any preceding clause, further comprising one or more stoppers arranged within the inner cavity of the magnet carrier for limiting movement of the counterweight within the magnet carrier.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A linear electric machine, comprising:
at least one shaft;
a stator assembly supporting the at least one shaft, the stator assembly comprising a magnet carrier supporting one or more magnets, the magnet carrier defining an inner cavity therein;
a bearing assembly supporting an end of the at least one shaft, the bearing assembly comprising a bearing housing and a bearing within the bearing housing; and
a counterweight positioned within the inner cavity of the magnet carrier for counteracting movement of the magnet carrier.

2. The linear electric machine of claim 1, wherein the counterweight is mounted within the inner cavity of the magnet carrier via at least one of a first spring or a first damper.

3. The linear electric machine of claim 2, wherein the counterweight is mounted within the inner cavity of the magnet carrier via the first spring and the first damper on a first side of the counterweight and a second spring and a second damper on an opposing, second side of the counterweight.

4. The linear electric machine of claim 3, wherein the counterweight is suspended within the inner cavity of the magnet carrier via the first spring, the first damper, the second spring, and the second damper.

5. The linear electric machine of claim 1, wherein the counterweight is mounted within the inner cavity of the magnet carrier via one or more bearings that allow the counterweight to slide along one or more inner surfaces of the inner cavity of the magnet carrier.

6. The linear electric machine of claim 5, wherein the counterweight further comprises one or more vent ports.

7. The linear electric machine of claim 5, wherein the magnet carrier further comprises one or more vent ports for allowing fluid to passively exit the inner cavity of the magnet carrier.

8. The linear electric machine of claim 1, further comprising one or more check valves for allowing fluid to enter the inner cavity of the magnet carrier, wherein the fluid is configured to move the counterweight within the inner cavity of the magnet carrier.

9. The linear electric machine of claim 8, wherein the one or more check valves comprise a first check valve and a second check valve, and wherein the first check valve allows the fluid to enter the inner cavity of the magnet carrier from a first side of the magnet carrier and the second check valve allows the fluid to enter the inner cavity of the magnet carrier from an opposing, second side of the magnet carrier.

10. The linear electric machine of claim 1, further comprising one or more stoppers arranged within the inner cavity of the magnet carrier for limiting movement of the counterweight within the magnet carrier.

11. The linear electric machine of claim 1, wherein a mass of the counterweight is proportional to a mass of the magnet carrier.

12. An assembly, comprising:
a closed-cycle engine;
a load device in magnetic communication with the closed-cycle engine via a shaft;
a piston assembly comprising pair of pistons each coupled to the shaft;
a stator assembly comprising a magnet carrier supporting one or more magnets and a plurality of windings wrapped circumferentially relative to the piston assembly, the magnet carrier defining an inner cavity therein;
a bearing assembly supporting an end of the shaft, the bearing assembly comprising a bearing housing and a bearing within the bearing housing; and
a counterweight positioned within the inner cavity of the magnet carrier for counteracting movement of the magnet carrier.

13. The assembly of claim 12, wherein the counterweight is mounted within the inner cavity of the magnet carrier via at least one of a first spring or a first damper.

14. The assembly of claim 13, wherein the counterweight is mounted within the inner cavity of the magnet carrier via the first spring and the first damper on a first side of the counterweight and a second spring and a second damper on an opposing, second side of the counterweight.

15. The assembly of claim 14, wherein the counterweight is suspended within the inner cavity of the magnet carrier via the first spring, the first damper, the second spring, and the second damper.

16. The assembly of claim 12, wherein the counterweight is mounted within the inner cavity of the magnet carrier via one or more bearings that allow the counterweight to slide along one or more inner surfaces of the inner cavity of the magnet carrier.

17. The assembly of claim 16, wherein the counterweight further comprises one or more vent ports.

18. The assembly of claim 16, wherein the magnet carrier further comprises one or more vent ports for allowing fluid to passively exit the inner cavity of the magnet carrier.

19. The assembly of claim 12, further comprising one or more check valves for allowing fluid to enter the inner cavity of the magnet carrier, wherein the fluid is configured to move the counterweight within the inner cavity of the magnet carrier, wherein the one or more check valves comprise a first check valve and a second check valve, and wherein the first check valve allows the fluid to enter the inner cavity of the magnet carrier from a first side of the magnet carrier and the second check valve allows the fluid to enter the inner cavity of the magnet carrier from an opposing, second side of the magnet carrier.

20. The assembly of claim 12, further comprising one or more stoppers arranged within the inner cavity of the magnet carrier for limiting movement of the counterweight within the magnet carrier.
